(19) United States
(12) Patent Application Publication
(10) Pub. No.: US 2003/0152046 A1
(43) Pub. Date: Aug. 14, 2003

(54) Communication apparatus, communication system and communication frequency setting method

(75) Inventor: Hiroaki Kawai, Inagi (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/196,217

(22) Filed: Jul. 17, 2002

(30) Foreign Application Priority Data
Feb. 14, 2002 (JP) 2002-36549

(51) Int. Cl. H04Q 7/00

(52) U.S. Cl. 370/328; 370/338; 370/329; 370/341; 370/348

(57) ABSTRACT

A communication apparatus is applicable to a communication system such as a wireless LAN, and is always capable of establishing good communications in an automatic and speedy manner thereby to eliminate human operations and achieve the low cost irrespective of the presence or absence of jam transmissions. The communication apparatus can wirelessly communicate with terminal devices 1A, 1B. A channel setting part 31 is able to set a plurality of communication frequency bands with a specific communication frequency band being set as a default. An SN ratio detection part 34 detects the communication conditions of a plurality of communication frequency bands, which can be set by the channel setting part 31, by detecting SN ratios thereof. A channel selection part 36 selects a communication frequency band whose SN ratio is the higher among the plurality of communication frequency bands based on the communication conditions detected by the SN ratio detection part 34, thereby enabling the channel setting part 31 to set the communication frequency band thus selected for communications.

### BACKGROUND OF THE INVENTION

1. Field of the Invention

The present invention relates to a communication apparatus and the like which is used in stores, premises, etc., and which acts as a repeater for performing communications between upstream equipment such as exchanges, switchboards, servers, etc., and downstream equipment such as portable terminal devices, and more particularly, it relates to a communication apparatus, a communication system and a communication frequency setting method for arbitrarily or properly changing an operating communication frequency band so as to perform communications under a good condition while avoiding the influences of jam transmissions, etc.

2. Description of the Prior Art

There has hitherto been known such a communication system (e.g., wireless LAN system) in which in cases where wireless or radio communications are carried out in premises, stores, etc., in a part of the zone or range between upstream equipment and downstream equipment for instance, provision is made for a repeater wireless or radio base station which is connected to the upstream equipement through a wire or cable, and the downstream equipment through wireless or radio communications.

In such a communication system, communications are carried out under the same environment in a fixed or limited area in premises, stores or the like, and hence as shown in FIG. 12 for instance, channels (ch 1 to ch 11) are allocated to communication frequency bands, respectively, so that communications are performed by setting as defaults these channels to wireless base stations, respectively. Thus, by doing communications with default settings in this manner, it becomes unnecessary to use complicated protocols such as those for cellular phones used in the public networks, thereby making it possible to carry out communications in a simple and smooth manner.

In the communication system illustrated in FIG. 12, a 2.4 GHz band of frequencies of 2.4 GHz-2.5 GHz is divided into 11 channels, and wireless or radio communications are performed by setting any one of these channels. In this case, however, the 2.4 GHz band includes, in addition to radio waves used in telecommunications equipment in wireless LANs, electromagnetic radiation from microwave ovens, radio waves from amateur radio stations, radio waves used in Bluetooth wireless communications, radio waves used in other forms of wireless LANs, etc. Therefore, in such a communication system, even if channels are set by default so as to avoid mutual interference, radio waves, electromagnetic radiation, etc., from other equipment as mentioned above might sometimes become jam transmissions depending upon the frequencies of these channels, thus resulting in a situation that any desirable communication condition might not be able to be obtained.

FIG. 13 is a flow chart showing an operation or use mode in such a known communication system. First of all, the frequency of each channel is set as a default by taking into account the arrangement and settings of a base station (step S101). Then, terminal devices for the base station are installed or operated (step S102), and if there takes place abnormal operation at this time (YES in step S103), the cause of such an abnormal operation is persued or diagnosed (step S104). When it is determined that the cause is jam transmissions such as radio waves from microwave ovens (YES in step S105), it is then confirmed or checked that another unused frequency band can provide good communications (step S106). Thereafter, the frequency band for that channel is changed to the unused frequency band (step S107).

In this manner, in the known communication system, the procedures (steps S104 through S107) from the step of pursuing or finding the cause (step S104) until the step of changing the operating or currently used frequency band to an unused frequency band (step S107) are carried out by human labor or operations according to a technical manual. As a result, it is difficult to take prompt countermeasures for coping with jam transmissions, and the labor cost has been increased. Here, note that if the cause is other than jam transmissions (NO in step S105, and step S108), other different countermeasures are needed (S109), but such countermeasures are irrelevant to the present invention, so any further explanation thereof will not be necessary and hence omitted.

### SUMMARY OF THE INVENTION

Accordingly, the present invention is intended to obviate the problems as referred to above, and has for its object to provide a communication apparatus, a communication system and a communication frequency setting method which are applicable to communication systems such as wireless LANs, and are always capable of establishing good communications in an automatic and speedy manner thereby to eliminate human operations and achieve the low cost irrespective of the presence or absence of jam transmissions.

To solve the above-mentioned problems, according to a first aspect of the present invention, there is provided a communication apparatus which is adapted to be connected to first equipment through a wired or wireless communications link, and to second equipment through wireless communications. The communication apparatus includes: band setting means capable of setting an arbitrary communication frequency band from among a plurality of communication frequency bands as well as setting a specific communication frequency band as a default setting in order to perform wireless communications; communication condition detection means for detecting the communication conditions of the plurality of communication frequency bands which can be set by the band setting means; and selection means for selecting a prescribed communication frequency band from the plurality of communication frequency bands based on the communication condition of the default set specific communication frequency band and the communication conditions of the plurality of communication frequency bands thereby to enable the band setting means to set the prescribed communication frequency band thus selected as an operating frequency band for communications with the second equipment.

In a preferred embodiment, the band setting means is constituted by a channel setting part, and the communication condition detection means is constituted by an SN ratio detection part which acts as a reception condition detection part. Also, the selection means is constituted by a channel selection part which acts as an operating channel selection means.

In a preferred form of the first aspect of the present invention, the communication condition detection means detects the communication conditions by detecting jam transmissions.

In another preferred form of the first aspect of the present invention, the communication condition detection means detects the communication conditions by detecting SN ratios.

In a further preferred form of the first aspect of the present invention, the detection of the communication conditions according to the communication condition detection means is carried out at the time when the communication apparatus is started to operate.

In a still further preferred form of the first aspect of the present invention, the detection of the communication conditions according to the communication condition detection means is carried out at regular intervals.

In a yet further preferred form of the first aspect of the present invention, the communication apparatus further includes storage means for storing the communication conditions of the plurality of communication frequency bands detected by the communication condition detection means. The selection means selects the prescribed communication frequency band based on the communication conditions stored in the storage means.

In a further preferred form of the first aspect of the present invention, the communication apparatus further includes status detection means for detecting communication frequency bands used in other communication apparatuses different from the communication apparatus concerned. The selection means further selects the prescribed communication frequency band from the plurality of communication frequency bands based on the status of the communication frequency bands detected by the status detection means.

In a further preferred form of the first aspect of the present invention, the communication apparatus is a wireless base station in a wireless LAN system.

According to a second aspect of the present invention, there is provided a communication system including a base station adapted to be connected to first equipment through a wired or wireless communications link, and second equipment adapted to connected to the base station through wireless communications thereby to perform communications with the first equipment. The base station includes: band setting means capable of setting an arbitrary communication frequency band from among a plurality of communication frequency bands as well as setting a specific communication frequency band as a default setting in order to perform wirelees communications; communication condition detection means for detecting the communication conditions of the plurality of communication frequency bands which can be set by the band setting means; and selection means for selecting a prescribed communication frequency band from the plurality of communication frequency bands based on the communication condition of the default set specific communication frequency band and the communication conditions of the plurality of communication frequency bands thereby to enable the band setting means to set the prescribed communication frequency band thus selected as an operating frequency band for communications with the second equipment. The second equipment includes communication frequency tracking means for enabling its transmission and reception communication frequency band to track the communication frequency band selected by the base station.

According to a third aspect of the present invention, there is provided a communication frequency setting method for performing wireless communications in a communication apparatus which is adapted to be connected to first equipment through a wired or wireless communication link, and to second equipment through wireless communications. The method includes: a default setting step for setting a specific communication frequency band from among a plurality of communication frequency bands as a default setting for communications; and a selection setting step for detecting the communication condition of each of the plurality of communication frequency bands and the communication condition of the default set specific communication frequency band thereby to selectively set an operating communication frequency band to any one of the plurality of communication frequency bands in place of the default set specific communication frequency band based on the communication condition of the default set specific communication frequency band.

In a preferred form of the third aspect of the present invention, the communication frequency setting method further includes an operating band detection step for detecting operating communication frequency bands used by other communication apparatuses different from the communication apparatus concerned. In the selection setting step, a prescribed communication frequency band is further selectively set from the plurality of communication frequency bands based on the operating communication frequency bands detected in the used band detection step.

In another preferred form of the third aspect of the present invention, the communication frequency setting method further includes a communication condition storing step for storing the communication conditions of the plurality of communication frequency bands. In the selection setting step, a prescribed communication frequency band is selectively set based on the communication conditions stored in the communication condition storing step.

In a further preferred form of the third aspect of the present invention, the communication frequency setting method further includes a communication condition detection step for detecting the communication condition of the communication frequency band set in the selection setting step thereby to select, based on the detection result, another communication frequency band different from the currently used communication frequency band from among the plurality of communication frequency bands stored in the communication condition storing step.

According to a fourth aspect of the present invention, there is provided a communication frequency setting method for performing wireless communications in a communication apparatus which is adapted to be connected to first equipment through a wired or wireless communication link, and to second equipment through wireless communications. The method includes: a default setting step for setting a specific communication frequency band from among a plurality of communication frequency bands as a default setting; a communication condition detection step for detecting the communication condition of the default set communication frequency band; and a selective setting step for detecting the communication condition of each of the plurality of communication frequency bands based on the detection result of the communication condition of the default set communication frequency band thereby to select, based on the communication conditions thus detected, a prescribed communication frequency band from the plurality of communication frequency bands and set the prescribed communication frequency band thus selected as an operating communication frequency in place of the default set communication frequency band.

According to the present invention, when the communication condition is deteriorated to such an extent as to require the changing of the operating communication frequency band, it is possible to select the best possible communication condition in the current state not based on the past detection results.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a block diagram showing the overall arrangement of a communication system according to a first embodiment of the present invention.

FIG. 2 is a block diagram showing the communication system of FIG. 1 in more detail.

FIG. 3 is a block diagram showing one example of an operating channel setting part of a base station.

FIG. 4 is a block diagram showing one example of a channel tracking circuit of a terminal device.

FIG. 5 is a flow chart illustrating the overall operation of the communication system according to the first embodiment of the present invention.

FIG. 6 is a flow chart illustrating the operation (channel search processing) of step S3 in FIG. 5.

FIG. 7 is a flow chart illustrating the processing of detecting jam transmissions by detecting the SN ratio.

FIG. 8 is a block diagram illustrating the overall arrangement of a communication system according to a second embodiment of the present invention.

FIG. 9 is a block diagram showing the communication system of FIG. 8 in more detail.

FIG. 10 is a block diagram showing one example of an operating channel setting part of a wireless base station.

FIG. 11 is a flow chart illustrating the operation of the second embodiment of the present invention.

FIG. 12 is a view showing the channel allocation of communication frequency bands in a wireless LAN.

FIG. 13 is a flow chart illustrating an overall operation as to how to use a known communication system.

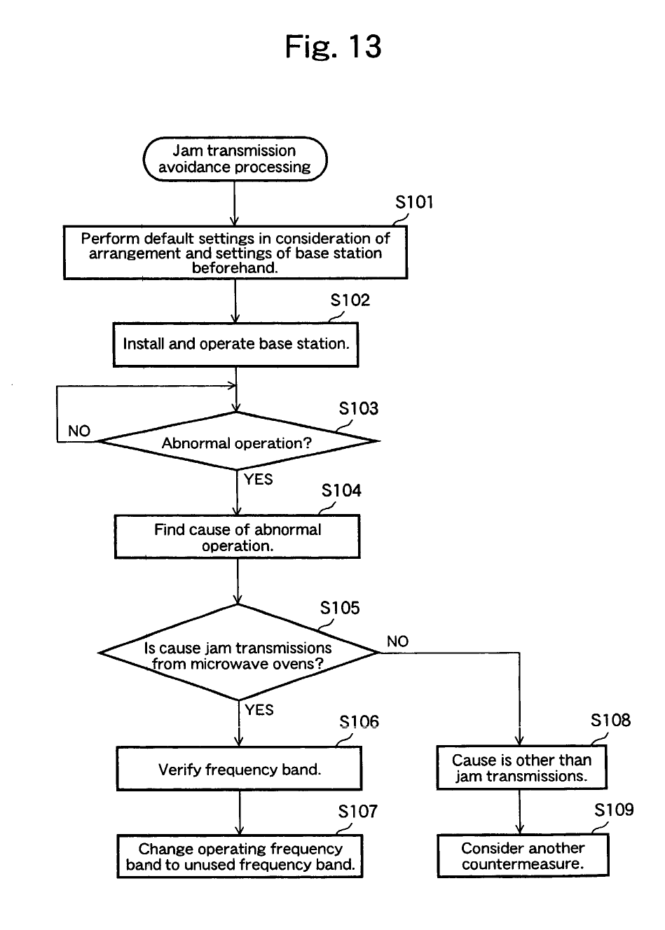

### DESCRIPTION OF THE PREFERRED EMBODIMENTS

Now, preferred embodiments of the present invention will be described below in detail with reference to the accompanying drawings while taking, as an example, a wireless LAN system which is installed in a store or premises.

Embodiment 1.

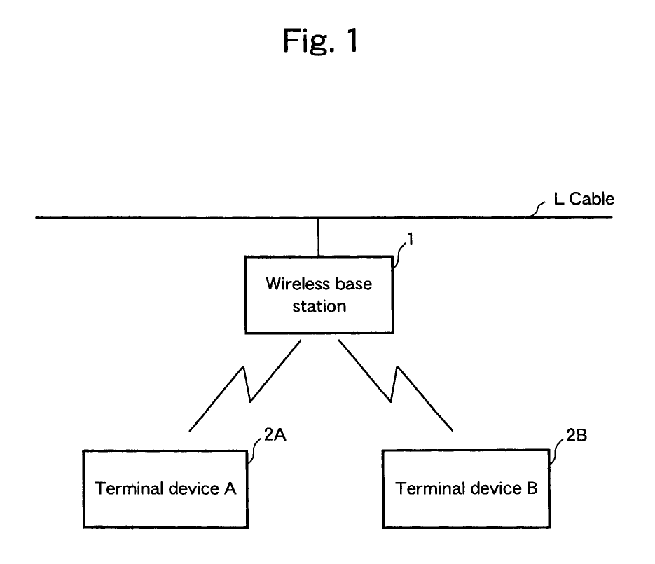

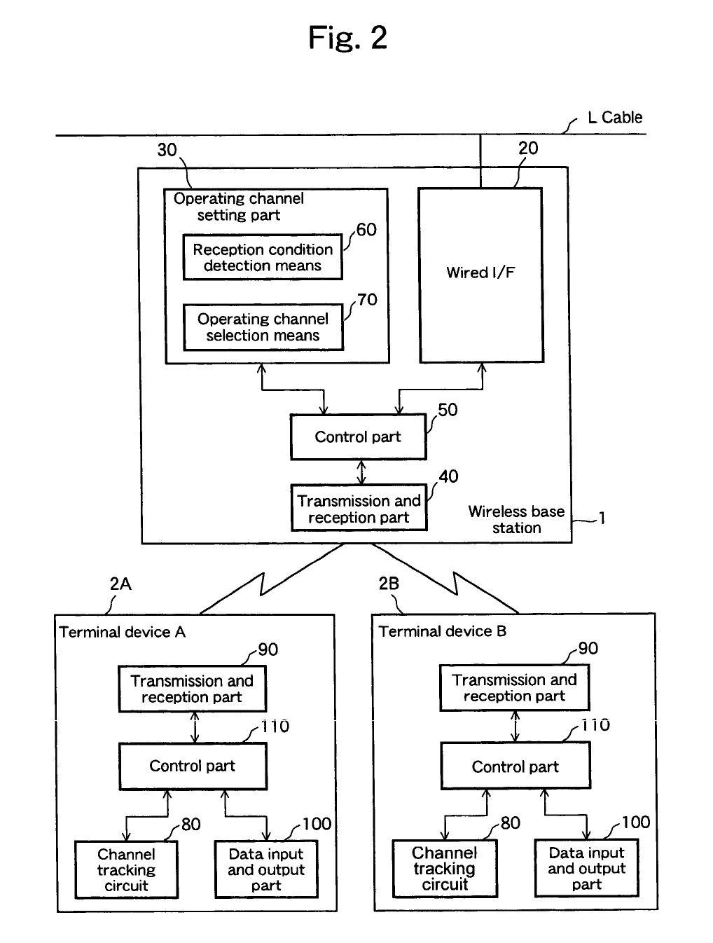

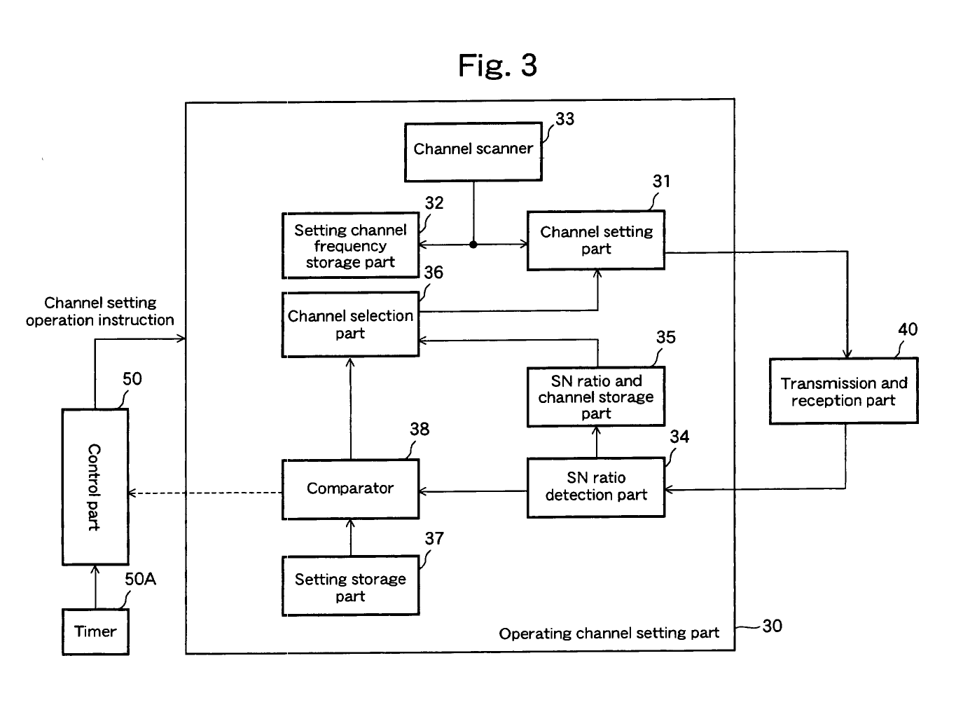

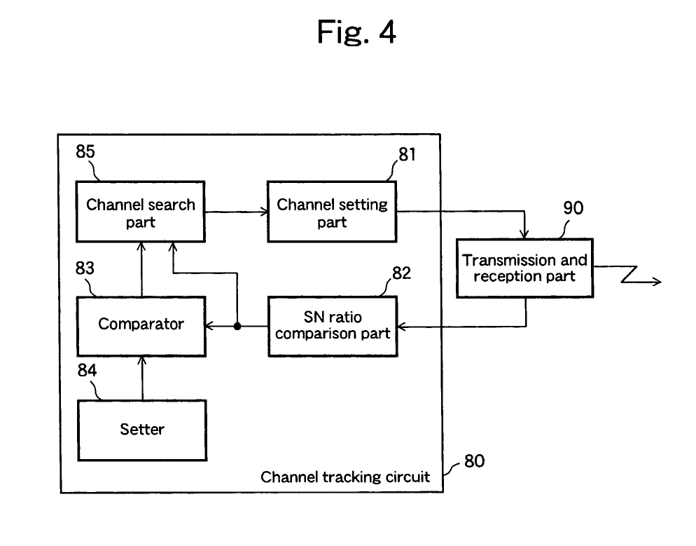

FIG. 1 is a block diagram which shows the overall arrangement of a communication system applied to a wireless LAN system in accordance with a first embodiment of the present invention. FIG. 2 is a block diagram which shows the communication system of FIG. 1 in more detail. FIG. 3 is a block diagram which illustrates one example of an operating channel setting part of a base station shown in FIG. 1. FIG. 4 is a block diagram which illustrates one example of a channel tracking circuit of a terminal device shown in FIG. 1. The wireless LAN system in this embodiment includes a wireless or radio base station 1 (communication apparatus) that is connected to unillustrated upstream equipment such as an exchange, a switchboard, a server or the like through a wire or cable L installed in a store, and a plurality of terminal devices 2A, 2B (second equipment) that are connected via radio communications to the wireless base station 1 and hence to the unillustrated upstream equipment (first equipment) through the wireless base station 1 which acts as a repeater.

As shown in FIG. 2, the wireless base station 1 includes a wired or cable interface 20 connected with the cable L, an operating channel setting part 30 for setting operating channels (ch) corresponding to a communication frequency band necessary to perform wireless or radio communications with the terminal devices 2A, 2B, a transmission and reception part 40 for performing data transmission with the terminal devices 2A, 2B by using the communication frequencies set in the operating channel setting part 30, and a control part 50 for controlling the wired interface 20, the operating channel setting part 30 and the transmission and reception part 40 to carry out communications control between the upstream equipment and the terminal devices 2A, 2B by forming data of a prescribed format. The operating channel setting part 30 includes, as its main components, a reception condition detection means 60 for detecting a reception condition as a communication condition, and an operating channel selection means 70 for selecting an operating channel to be used based on the reception condition.

Each of the terminal devices 2A, 2B includes a channel tracking circuit 80 for tracking the operating channel of the wireless base station 1 so as to perform communications at the communication frequency band used by the wireless base station 1, a transmission and reception part 90 for performing data transmission with the wirelees base station 1 at the channel which is tracked by the channel tracking circuit 80, a data input and output part 100 for inputting and outputting data that is transmitted or received by the transmission and reception part 90, and a control part 110 for controlling the channel tracking part 80, the transmission and reception part 90 and the data input and output part 100 to carry out communications control between the wireless base station 1 and the terminal devices 2A, 2B by forming data of the prescribed format.

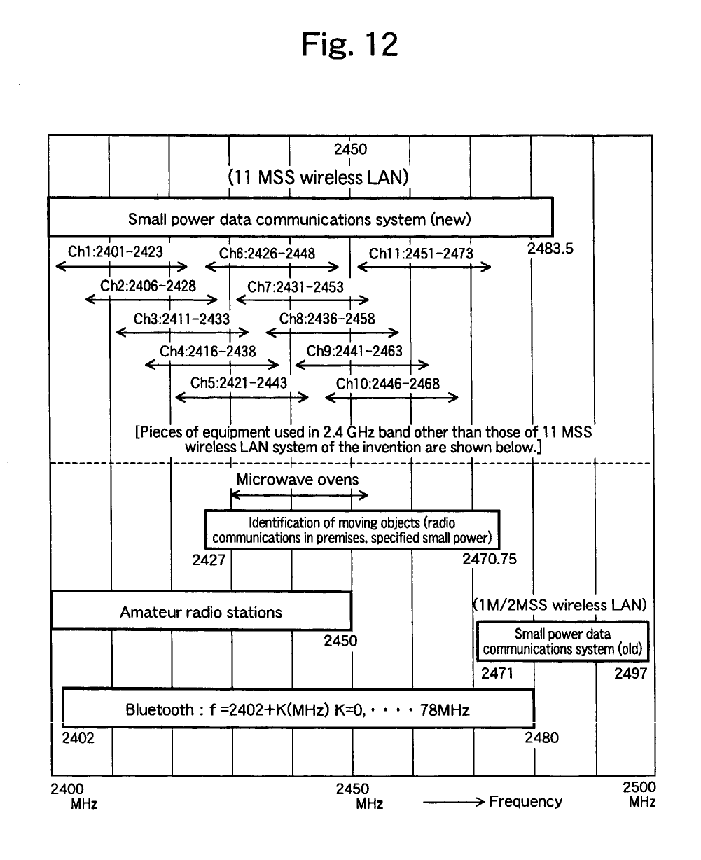

As shown in FIG. 3, the operating channel setting part 30 in the wireless base station 1 includes a channel (Ch) setting part 31 for setting a channel corresponding to any one of the communication frequency bands (i.e., ch 1-ch 11 in FIG. 12) so as to enable the transmission and reception part 40 to perform communications at a frequency of the channel thus set, a setting channel frequency storage part 32 for storing a plurality of communication frequency bands used to communicate as corresponding channels (ch 1-ch 11) allotted thereto, a channel (Ch) scanner 33 for sequentially setting the respective channels in the channel setting part 31 thereby to perform communications by use of all channels for channel search, an SN ratio detection part 34 for detecting the communication condition of the wireless base station 1 by detecting the SN ratio (SNR) of a reception signal from the transmission and reception part 40, an SN ratio and channel storage part 35 for storing the SN ratio in each channel detected by the SN ratio detection part 34, and a channel selection part 36 for selecting the channel of the highest SN ratio from among those channels which are stored in the SN ratio and channel storage part 35 and which are not currently used, as will be described later in detail, thereby to set the channel thus selected in the channel setting part 31. Here, note that at the initial stage of communications, a prescribed channel is set by default in the channel setting part 31.

The operating channel setting part 31 includes a comparator 38 which communications with a prescribed set value (a threshold such as, for instance, the SN level at the time of the power supply being turned on) stored in the setting storage part 37, and outputs a channel change instruction to the channel selection part 36 when the SN ratio has been decreased from the prescribed set value by a level equal to or greater than a certain threshold. The channel selection part 36 selects the channel of the highest SN ratio from among those channels which are stored in the SN ratio and channel storage part 35 and which are not currently used in accordance with a channel change instruction from the comparator 38, as described above, and sets the channel thus selected in the channel setting part 31. Such a configuration provides an advantage that when the current communication condition is deteriorated, the operating communication frequency band (channel) can be changed in an extremely prompt manner.

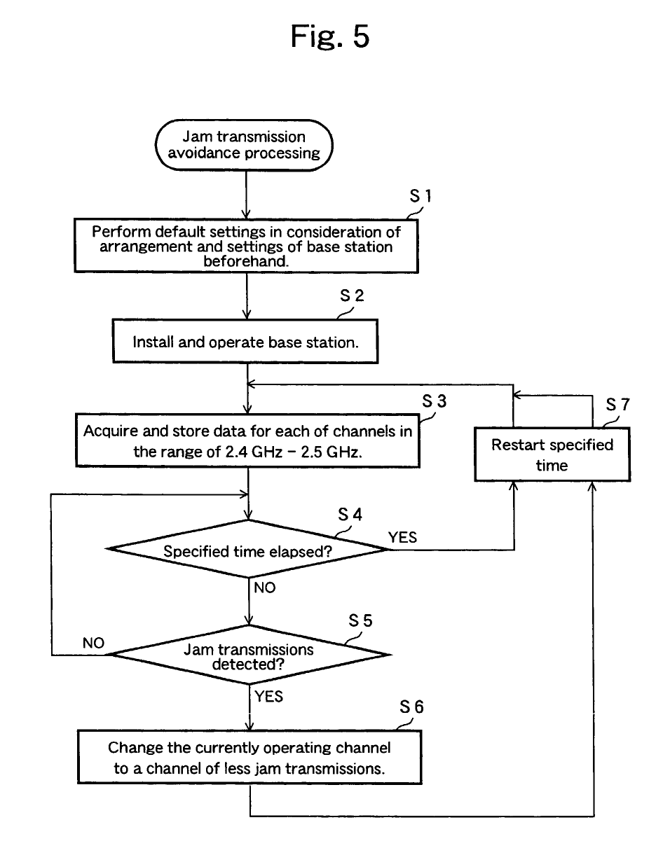

Here, it is to be noted that the configuration of the operating channel setting part 30 as mentioned above is only one example, and if, for instance, the SN ratio is deteriorated in the course of communications, a channel change instruction from the comparator 38 may be output not to the channel selection part 36 but to the control part 50, as shown by the broken line in FIG. 3, so that the control part 50, which receives this channel change instruction, drives the channel scanner 33 to perform a re-search for the communication frequency bands, thereby re-setting the operating channel in the channel setting part 31. In this manner, if it is constructed such that every time a channel change instruction is given, the control part 50 drives the channel scanner 33 to re-search the operating communication frequency bands, it is possible to perform communications while avoiding jam transmission bands in a reliable manner without knowing the jam transmission bands for instance. In addition, in this embodiment, each time a prescribed or specified time has elapsed, which is detected or measured by a timer 50A provided in the control part 50, a search is made for the above-mentioned communication frequency bands (channels), and the search result is stored in the SN ratio and channel storage part 35. In this connection, note that a channel with the best communication condition (i.e., the highest SN ratio representative of the reception condition) may be re-set as the operating channel in the channel setting part 31 at intervals of a prescribed time. Moreover, in the explanation of the operation of the system with reference to FIG. 5 to be described later, a re-search for channels is carried out whenever there takes place a channel change. However, whenever the communication condition deteriorates during the prescribed time, the following channel candidate may be selectively set from the SN ratio and channel storage part 35. In this case, for example, the order of the channel candidates can be set according to the reception conditions of the respective channels stored in the SN ratio and channel storage part 35.

As shown in FIG. 4, one example of the configuration of the channel tracking circuit 80 in each of the terminal devices 2A, 2B may include a channel setting part 81 for setting an operating channel for communications, an SN ratio detection part 82 for detecting the SN ratio of a signal received by the transmission and reception part 90, a comparator 83 and a setter 84 for comparing the SN ratio detected by the SN ratio detection part 82 with a prescribed set value (threshold) and for starting a channel search when the SN ratio becomes smaller than the set value, and a channel search part 85 which starts a channel search based on an instruction from the comparator 83, and sets the channel of the highest SN ratio in the channel setting part 81 based on the SN ratios from the SN ratio detection part 82. Here, note that such a configuration of the channel tracking circuit 80 is only one example. Thus, for instance, it may be constructed such that an operating channel is set in accordance with an instruction designating or specifying the operating channel, which is received from the wireless base station 1, and hence it is needless to say that the present invention is not limited to these configurations.

Now, the operation of the first embodiment will be described below in more detail. FIG. 5 is a flow chart which shows the overall operation of the first embodiment of the present invention. First of all, by taking into consideration the arrangement and settings of the wireless base station 1 in advance, a default setting is carried out for an appropriate channel (step S1). Then, the wireless base station 1, for which the default setting of the channel has been done, is installed and operated in an appropriate location (step S2), and the reception condition (SN ratio) of each channel in the 2.4 GHz band is detected according to the operation as explained with reference to FIG. 3, and the data thus detected is stored in the SN ratio and channel storage part 35 (step S3). Thereafter, it is determined whether a specified time has elapsed (step S4). If not yet elapsed (NO in step S4),it is then determined whether jam transmissions are detected (i.e., whether the SN ratio is lower than a set value) (step S5). If jam transmissions are detected (YES in step S5), the setting of the operating channel is changed to another channel which has the highest value among the SN ratios stored in the SN ratio and channel storage part 35 (step S6). Thereafter, the timer 50A is initialized (step S7), and a return to step S3 is carried out. On the other hand, if it is determined in step S4 that the specified time has elapsed (YES), the timer 50A is then reset (step S7), and the operation in step S3 is carried out again. Also, if jam transmissions are not detected in step S5 (NO), the operation of detecting jam transmissions in step S5 is repeated until the specified time has elapsed (YES in step S4).

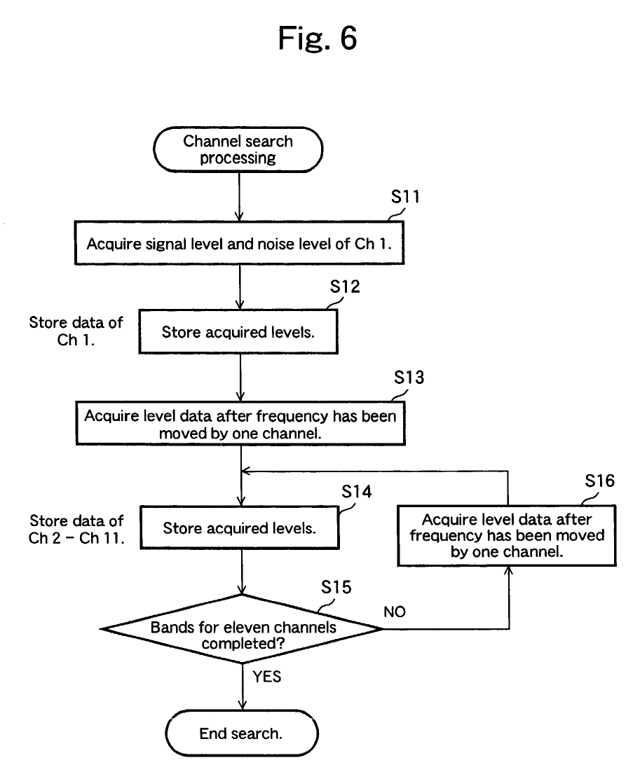

FIG. 6 is a flow chart which shows the operation (i.e., channel search processing) in step S3 of FIG. 5. This channel search processing is performed when a beacon is sent from the wireless base station 1 at intervals of 100 ms to the terminal devices 2A, 2B to form communication links therewith after the power supply is turned on. For instance, the signal level and the noise level in each wireless communication area (i.e., between the wireless base station 1 and the terminal devices 2A, 2B) are detected by transmitting or exchanging data with certain information added to the header of each frame in an 802.11b-compliant complaint frame format for example. Her note that each frame contains pieces of information such as addresses in the form of MAC addresses for identifying the information equipment connected with the LAN, the frame type, the transmission rate of the data frame, etc. Hereinafter, reference will be made to the channel search processing operation. First of all, by acquiring the signal level and the noise level of channel (ch 1) (step S11), the SN ratio are obtained and stored in the SN ratio and channel storage part 35 (step S12). Then, the frequency band is moved by one channel and then the SN ratio is obtained in the same manner (step S13). The SN ratio thus obtained is stored in the SN ratio and channel storage part 35 (step S14). The above operations are repeated for eleven channels (steps S14, 315 and S16), and then the channel search processing is finally ended.

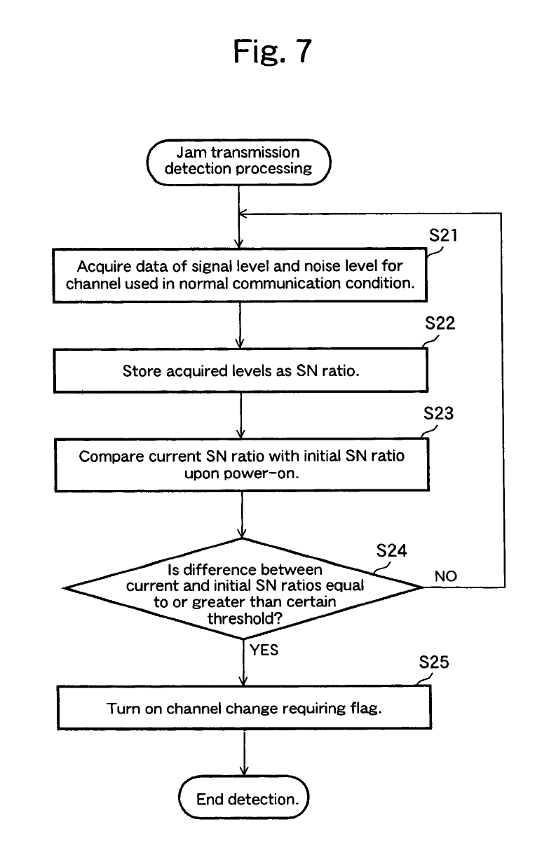

FIG. 7 is a flow chart which shows the detection processing for jam transmissions performed by detecting the SN ratio.

First, the SN ratio in the communication state of the system is obtained by acquiring the signal level and the noise level (step S21). Then, the SN ratio thus obtained is stored in the SN ratio and channel storage part 35 (step S22), and the obtained SN ratio is compared with the initial SN ratio (i.e., prescribed set value) at the time when the power supply is turned on (step S23). If the obtained SN ratio is lower than the initial SN ratio by a level or value equal to or greater than a prescribed threshold (i.e., if the difference between the obtained SN ratio and the initial SN ratio is equal to or greater than the prescribed threshold), a channel change requiring flag for instructing a channel change is turned on (step S25).

Embodiment 2.

The aforementioned first embodiment has described the case where there exists one wireless base station, but when there are two or more wireless base stations, the frequency bands (channels) used by the wireless base stations might interfere with each other, thereby worsening their communication conditions. A second embodiment of the present invention is intended to solve such a situation, i.e., to avoid mutual interference due to the frequency bands (channels) used by a plurality of wireless base stations.

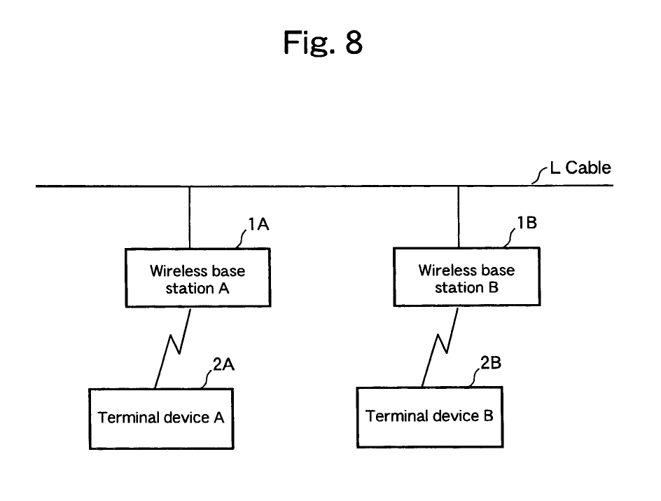

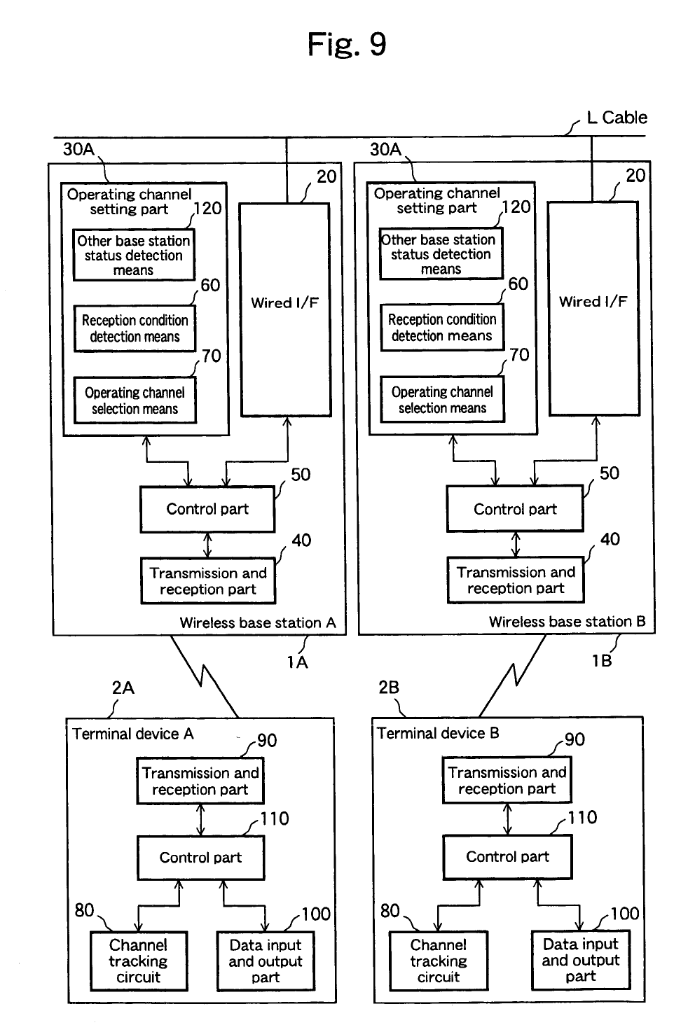

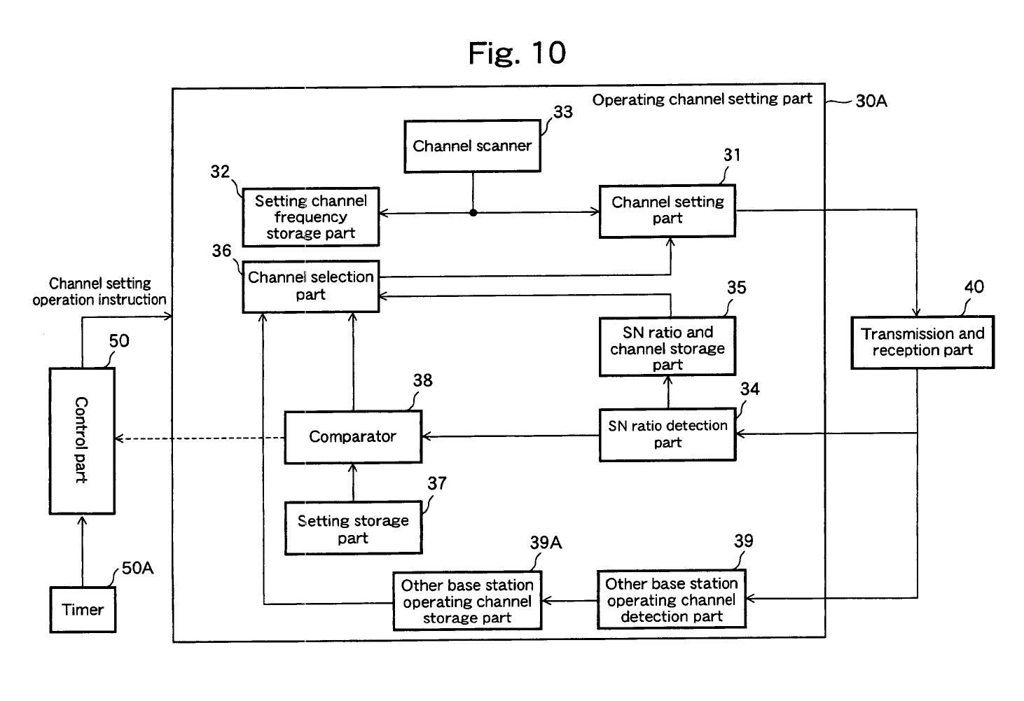

FIG. 8 is a block diagram which shows the overall arrangement of a communication system according to the second embodiment of the present invention. FIG. 9 is a block diagram which shows the arrangement of FIG. 8 in more detail. FIG. 10 is a block diagram which shows one example of an operating channel setting part of each base station. Here, note that in these figures, the same symbols as those in FIG. 1 through FIG. 3 designate the same or corresponding parts or elements as those shown in FIG. 1 through FIG. 3, and an explanation thereof is omitted.

In FIG. 8, two (plural) wireless base stations 1A, 1B are connected with the cable L arranged in a store or the like. Terminal devices 2A, 2B are provided for the wireless base stations 1A, 1B, respectively, for communications therewith. In FIG. 9, an other base station status detection means 120 for detecting communication frequency bands (channels) used in other adjacent base stations is added to the configuration of the wireless base station 1 shown in FIG. 2, i.e., to the operating channel setting part 30 thereof. The configuration of each of the wireless base stations 1A, 1B other than this is the same as the wireless base station 1 of FIG. 2.

More specifically, the configuration of the operating channel setting part 30A shown in FIG. 10 includes the following components newly added to the configuration of the operating channel setting part 30 shown in the first embodiment. That is, the operating channel setting part 30A additionally includes an other base station operating channel detection part 39 which is connected to the output side of the transmission and reception part 40 so as to detect the operating channel of the other base station, and an other base station operating channel storage part 39A wich stores the operating channel of the other base station detected by the other base station operating channel detection part 39, and which gives the information stored therein to the channel selection part 36 as necessary. The channel selection part 36 is constructed such that it selects the channel whose communication condition (reception condition) is the best (i.e., the SN ratio being the highest) among the channels not used by the own base station and the other base station from the SN ratio and channel storage part 35 based on a channel change instruction from the comparator 38 and the other base station operating channel information from the other base station operating channel storage part 39A, and provides the channel thus selected to the channel setting part 31.

Here, note that the configuration of the operating channel setting part 30A as mentioned above is only one example of the present invention, as explained in the operating channel setting part 30 of the first embodiment. For instance, the operating channel setting part 30A may be constructed in the following manner. That is, when the SN ratio is deteriorated during communications, a channel change instruction is output from the comparator 38 to the control part 50, as shown by the broken line in FIG. 10, so that the control part 50 receiving the channel change instruction from the comparator 38 drives the channel scanner 33 thereby to performs a re-search for communication frequency bands. The result of the re-search is stored in the SN ratio and channel storage part 35, and the channel selection part 36 sets the channel, the communication condition of which is the best among those channels which are not used by the other base station, in the channel setting part 31. Here, it is to be noted that in the second embodiment, too, a search for the above-mentioned communication frequency bands (channels) is made each time the lapse of a specified time is detected or measured by the timer 50A which is provided in the control part 50, whereby the channel whose communication condition (i.e., the SN ratio representative of the reception condition) is the best among the channels not used by the other base station is re-set at intervals of a predetermined time.

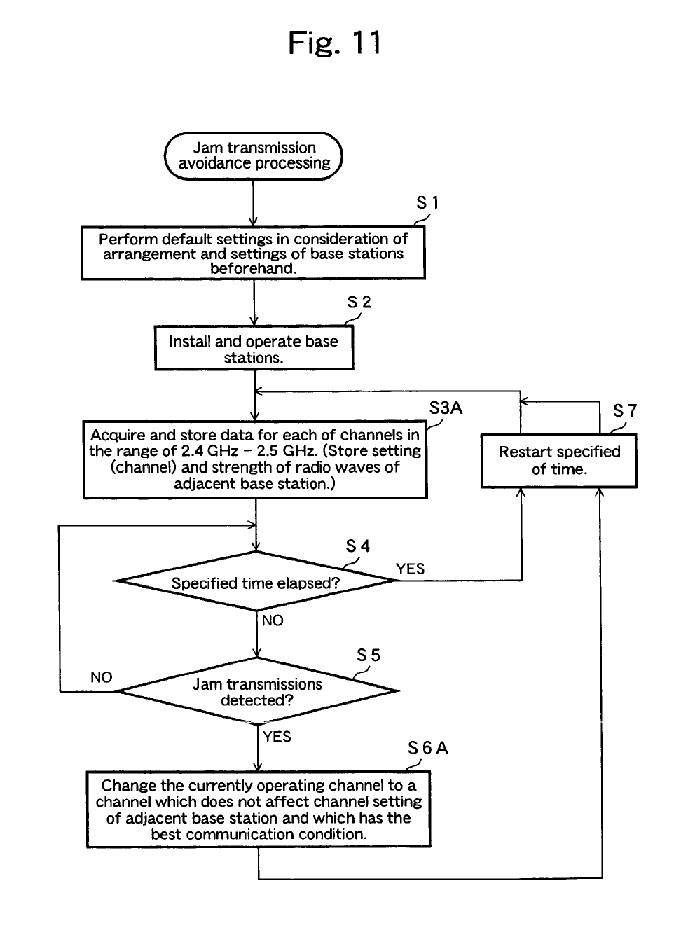

Hereinafter, the operation of the second embodiment will be described while using FIG. 11. First of all, by taking into consideration the arrangement and settings of the wireless base stations 1A, 1B in advance, a default setting is carried out for an appropriate channel in each of the wireless base stations 1A, 1B (step S1). Then, the wireless base stations 1A, 1B, for each of which the default setting of the operating channel has been done, are installed and operated in appropriate locations (step S2), and the reception condition (SN ratio) of each channel in the 2.4 GHz band in each wireless base station is detected, so that the data thus detected is stored in the SN ratio and channel storage part 35 of the operating channel setting part 30A in each wireless base station, and at the same time, the operating (set) channel and the strength of radio waves of the other adjacent wireless base station are also stored immediately after the power supply to each wireless base station is turned on (step S3A). Here, note that the detection and storing of the channel status (operating or used condition) in the other wireless base station are carried out before a beacon is sent to the terminal devices 2A, 2B to form communication links therewith. Thereafter, it is determined whether a specified time has elapsed (step S4). If not yet elapsed (NO in step S4),it is then determined whether jam transmissions are detected (i.e., whether the SN ratio is lower than a set value) (step S5). If jam transmissions are detected (YES in step S5), the setting of the operating channel is changed to another channel which is not used by the other wireless base station and which has the highest value among the SN ratios stored in the SN ratio and channel storage part 35 (step S6A). Thereafter, the timer 50A is initialized (step S7), and a return to step S3A is carried out. On the other hand, if it is determined in step S4 that the specified time has elapsed (YES), the timer 50A is then reset and the operation in step S3A is performed again. Also, if jam transmissions are not detected in step S5 (NO), the operation of detecting jam transmissions in step s S5 is repeated until the specified time has elapsed (YES in step S4).

The channel search processing as shown in FIG. 6 and the processing of detecting jam transmissions as shown in FIG. 7 in the first embodiment are similarly carried out in the second embodiment, too, and hence an explanation thereof is omitted.

Although in the above description, each wireless base station 1, 1A or 1B is connected to the upstream equipment through the wire or cable L, communication links therebetween may be formed through wireless or radio communications without using the hard wire or cable.

As described in detail in the foregoing, the present invention is applicable to a communication system such as a wireless LAN or the like, so that it is possible to establish good communications at all times in an automatic and prompt manner irrespective of the presence or absence of jam transmissions, thus making human labor or operations unnecessary and achieving the low cost.

While the invention has been described in terms of preferred embodiments, those skilled in the art will recognize that the invention can be practiced with modifications within the spirit and scope of the appended claims.

What is claimed is:

1. A communication apparatus which is adapted to be connected to first equipment through a wired or wireless communications link, and to second equipment through wireless communications,
said communication apparatus comprising:
band setting means capable of setting an arbitrary communication frequency band from among a plurality of communication frequency bands as well as setting a specific communication frequency band as a default setting in order to perform wireless communications;
communication condition detection means for detecting the communication conditions of the plurality of communication frequency bands which can be set by said band setting means; and
selection means for selecting a prescribed communication frequency band from said plurality of communication frequency bands based on the communication condition of said default set specific communication frequency band and the communication conditions of said plurality of communication frequency bands thereby to enable said band setting means to set the prescribed communication frequency band thus selected as an operating frequency band for communications with said second equipment.

2. The communication apparatus according to claim 1, wherein said communication condition detection means detects said communication conditions by detecting jam transmissions.

3. The communication apparatus according to claim 1, wherein said communication condition detection means detects said communication conditions by detecting SN ratios.

4. The communication apparatus according to claim 1, wherein the detection of said communication conditions according to said communication condition detection means is carried out at the time when said communication apparatus is started to operate.

5. The communication apparatus according to claim 1, wherein the detection of said communication conditions according to said communication condition detection means is carried out at regular intervals.

6. The communication apparatus according to claim 1, further comprising:
storage means for storing the communication conditions of the plurality of communication frequency bands detected by said communication condition detection means,
wherein said selection means selects said prescribed communication frequency band based on the communication conditions stored in said storage means.

7. The communication apparatus according to claim 1, further comprising:
status detection means for detecting communication frequency bands used in other communication apparatuses different from said communication apparatus concerned,
wherein said selection means further selects said prescribed communication frequency band from said plurality of communication frequency bands based on the status of said communication frequency bands detected by said status detection means.

8. The communication apparatus according to claim 1, wherein said communication apparatus is a wireless base station in a wireless LAN system.

9. A communication system including a base station adapted to be connected to first equipment through a wired or wireless communications link, and second equipment adapted to connected to said base station through wireless communications thereby to perform communications with said first equipment,
said base station comprising:
band setting means capable of setting an arbitrary communication frequency band from among a plurality of communication frequency bands as well as setting a specific communication frequency band as a default setting in order to perform wireless communications;
communication condition detection means for detecting the communication conditions of the plurality of communication frequency bands which can be set by said band setting means; and
selection means for selecting a prescribed communication frequency band from said plurality of communication frequency bands based on the communication condition of said default set specific communication frequency band and the communication conditions of said plurality of communication frequency bands thereby to enable said band setting means to set the prescribed communication frequency band thus selected as an operating frequency band for communications with said second equipment;
said second equipment comprising communication frequency tracking means for enabling its transmission and reception communication frequency band to track the communication frequency band selected by said base station.

10. A communication frequency setting method for performing wireless communications in a communication apparatus which is adapted to be connected to first equipment through a wired or wireless communication link, and to second equipment through wireless communications,
said method comprising:
a default setting step for setting a specific communication frequency band from among a plurality of communication frequency bands as a default setting for communications; and
a selection setting step for detecting the communication condition of each of the plurality of communication frequency bands and the communication condition of said default set specific communication frequency band thereby to selectively set an operating communication frequency band to any one of said plurality of communication frequency bands in place of said default set specific communication frequency band based on the communication condition of said default set specific communication frequency band.

11. The communication frequency setting method according to claim 10, further comprising:
an operating band detection step for detecting operating communication frequency bands used by other communication apparatuses different from said communication apparatus concerned,
wherein in said selection setting step, a prescribed communication frequency band is further selectively set from said plurality of communication frequency bands based on the operating communication frequency bands detected in said used band detection step.

12. The communication frequency setting method according to claim 10, further comprising:
a communication condition storing step for storing the communication conditions of said plurality of communication frequency bands,
wherein in said selection setting step, a prescribed communication frequency band is selectively set based on the communication conditions stored in said communication condition storing step.

13. The communication frequency setting method according to claim 12, further comprising:
a communication condition detection step for detecting the communication condition of said communication frequency band set in said selection setting step thereby to select, based on the detection result, another communication frequency band different from the currently used communication frequency band from among said plurality of communication frequency bands stored in said communication condition storing step.

14. A communication frequency setting method for performing wireless communications in a communication apparatus which is adapted to be connected to first equipment through a wired or wireless communication link, and to second equipment through wireless communications,
said method comprising:
a default setting step for setting a specific communication frequency band from among a plurality of communication frequency bands as a default setting;
a communication condition detection step for detecting the communication condition of said default set communication frequency band; and
a selective setting step for detecting the communication condition of each of the plurality of communication frequency bands based on the detection result of the communication condition of said default set communication frequency band thereby to select, based on the communication conditions thus detected, a prescribed communication frequency band from said plurality of communication frequency bands and set the prescribed communication frequency band thus selected as an operating communication frequency in place of said default set communication frequency band.
